(19) United States
(12) Patent Application Publication
(10) Pub. No.: US 2010/0095639 A1
(43) Pub. Date: Apr. 22, 2010

(54) METHOD FOR SPRAYING THE EXTERIOR SURFACES OF BLOW MOLDED PLASTIC BEVERAGE BOTTLES WITH A TREATMENT TO MINIMIZE, RESTRICT, OR INHIBIT BOTTLE JAMS DURING THE USE OF AN AIR TRANSPORT SYSTEM IN A BOTTLE PLANT

(76) Inventors: Michael HOHENHORST, Beckum (DE); Martin BACKHAUS, Unna (DE)

Correspondence Address: NILS H. LJUNGMAN & ASSOCIATES, P. O. BOX 130, GREENSBURG, PA, 15601-0130, US

(21) Appl. No.: 12/425,948

(22) Filed: Apr. 17, 2009

Related U.S. Application Data
(63) Continuation-in-part of application No. PCT/EP2007/008931, filed on Oct. 15, 2007.

(30) Foreign Application Priority Data
Oct. 18, 2006 (DE) 10 2006 049 134.3
Oct. 18, 2006 (DE) 20 2006 015 912.6

(51) Int. Cl. B65B 65/06; B65B 3/02; B65B 7/28; B05D 3/02

(52) U.S. Cl. 53/452; 53/561; 427/372.2; 118/300

(57) ABSTRACT

A method for spraying the exterior surfaces of blow molded plastic beverage bottles with a treatment to minimize, restrict, or inhibit bottle jams during the use of an air transport system. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2007/008931, filed on Oct. 15, 2007 which claims priority from Federal Republic of Germany Patent Application No. 10 2006 049 134.3, filed on Oct. 18, 2006 and Federal Republic of Germany Patent Application No. 20 2006 015 912.6 Oct. 18, 2006. International Patent Application No. PCT/EP2007/008931 was pending as of the filing date of this application. The United States was an elected state in International Patent Application No. PCT/EP2007/008931.

### BACKGROUND

1. Technical Field

The present application relates to a procedure and a device for the treatment of containers made from plastic material.

2. Background Information

Background information is for informational purposes only and does not necessarily admit that subsequently mentioned information and publications are prior art.

Plastic containers are used, for instance, as packaging for drinks, or liquid beverages. In typical plant arrangements the containers are produced as plastic bottles by blow molding from so-called pre-forms, or pre-form structures. This production process occurs often prior to the filling with the filling material in a coherent plant arrangement.

In addition, the so-called pre-forms, delivered as a pour-able aggregate, are brought into the blow molding machine, are heated in a controlled manner, and in a following blow-molding station they are shaped by blow molding at a high production rate. For this different machines are used which comprise, for example, a plurality of rotating blow-molding arrangements, in order to achieve high output capacities.

After the blow molding, the molded containers are supplied to the other plant locations, for instance, to a rinser, or filling arrangement, or filling station. The individual plant locations, or stations are tuned, or operated in synchronism, such that, for instance, the blow-molding machine can place at disposal enough containers to enable the filling machine to continuously perform continuous filling of the containers to be filled also at the highest production rate.

Nevertheless, changes, or operational fluctuations may never totally, or substantially totally avoided, restricted, or minimized, in the throughput of the individual plant stations, for instance, due to disturbances, or variations in the product supply and such variations can lead to an occasional reduction, for instance, of the filling speed. In order to compensate for such variations, between the single plant stations often buffer distances are planned which can compensate for an overproduction of the preceding plant station for a certain period of time. Thus operational traffic jams and disturbances are avoided, restricted, or minimized in a plant station that does not affect directly all, most, or substantially all plant stations, so that emergency shut-downs are avoided, restricted, or minimized, and instead, slower and uniform production increases, or decreases can occur in all, most, or substantially all plant production stations.

Air transport systems are often used for the transport, or conveying of the empty plastic containers. The pre-form structures, or bodies made of plastic material obtained as is described in the foregoing procedure have at their neck area a circular, ring-shaped collar which is independent of the size of the container and usually at the same location, and, in addition, independent of the kind of the respective container, and also usually has the same form. In the air transport systems the containers with this collar are moved in a canal, in which air nozzle formed like gills, or at an angle blow sterile pressure air under the collar and thus the containers can move forward with very low friction. The entire air transport system can be configured as a closed loop which has the additional advantage that a soiling of the inside of the container is substantially precluded. Furthermore, such transport systems are configured basically independent of the container size, since, as mentioned, also different container types independent of their size at the head, or mouth portion are uniformly constructed and can be moved therefore by the same transport systems.

The air transport systems are very long according to the size of the plant so as to be able to be used as a buffer distance and the like. Furthermore, they are configured to take up a very large number of plastic containers at the same time.

Here the problem arises that the containers, on account of the low friction during the transport, sometimes do not move forward at a steady speed, but the containers are subjected to operational variations. Furthermore, the containers carry out uncontrolled turning movements. As soon as two containers collide in the transport system, therefore, undesirable effects can arise. Because the guiding occurs exclusively at the head, or mouth portion, and the containers hang freely with their lower part, upon collision between containers they may be pushed to the side and may become stuck to one another. Such effects can arise upon colliding of containers that are turning relative with respect to one another. High transport speeds and capacities of the arrangement, thus, can give rise to disturbances which have extremely negative effects on the production achievement of a whole arrangement, or plant.

It is known to provide so-called pre-forms already during their production process with a silicone coating. However, these coatings have the disadvantage that they are prohibited in a food industry environment, because it cannot be guaranteed or essentially guaranteed that the inside of the thusly made, or coated bottles are free of pollution by silicone. Therefore, such so-called pre-forms are not suitable for arrangements of the described type and for the use, for example, in the beverage industry area.

### OBJECT OR OBJECTS

A task, or object of the present application is to treat the containers in a manner that they can be transported with reduced susceptibility to disruption, by substantially decreasing the interaction of the containers.

### SUMMARY

The present application attains this task, or object, by a treatment of containers made from plastic material. The containers are treated upon molding for the substantial removal, and/or the creation of an equilibrium of electrostatic surface loads, and/or for the reduction of the surface friction. This task or object is also attained as a device for the treatment of containers made from plastic material according to the present application.

By means of such a treatment the reciprocal influence of the containers with respect to each other while they are conveyed is considerably reduced. Thus it is avoided, restricted, or minimized that the containers get wedged in contact, or wedge tight with respect to each other. In this way, disturbances are considerably decreased during the transport, or are substantially completely avoided, restricted, or minimized. The procedure is useful in one possible embodiment when use is made of air transport systems; however, the method can also be used in one possible embodiment with other customary transport equipments.

In another possible embodiment of the present application, the plant arrangement can be configured so that the inside of the container is not treated, and so that a contamination by the medium of treatment is prevented, restricted, or minimized which is useful in one possible embodiment for applications in the food industry environment.

In at least one possible embodiment, the containers are sprayed on their outside with a means leading to the reduction of the friction. For this, a mixture of a carrier means and an effective, or active component can be used, for instance, when water is used as the carrier means, as an effective component, for instance, there are used means for the decrease of the surface tension, or means for the change of the conductivity, such as a rinsing liquid, or washing liquid, or cleansing liquid, or silicone or, however, also Teflon.

In other words and in accordance with at least one possible embodiment of the present application, the exterior surfaces of the containers are treated to reduce friction and/or electrostatic. In order to reduce friction and/or electrostatic, a mixture, suspension, or solution is sprayed on the exterior surface of the containers. This mixture, suspension, or solution could contain a liquid component such as water to allow sprayers to produce a mist or stream to coat the bottles with the mixture, suspension, or solution. The mixture, suspension, or solution contains a material to reduce static and/or friction. These materials could include a rinsing liquid, washing liquid, cleansing liquid, silicone, and/or Teflon.

Subsequently, it is suitable to dry the containers whereby in one embodiment this is under utilization of calorific values that the containers still hold following blow molding. Alternatively or, in addition, the used air from the air transport system can be used if this is directed, or channeled in suitable direction. If necessary or desired, there may be used a drying station, for instance, operated to provide an infrared heat treatment, or a flow of hot air.

In this way the carrier means dry up and mostly the effective component stays behind on the container surface where it contributes to the reduction of friction of the containers with respect to one another. For example, the water evaporates, leaving the means or effective component on the surface of the container. Any still present electrostatic charges, arisen during blow forming treatment, of the container are likewise reduced by the treatment, or are substantially completely removed so that through this method, an interaction of the containers with each other is likewise substantially prevented, restricted, or minimized.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application is further described with reference to drawings, in which:

FIG. 1 shows a block diagram of an arrangement in accordance with the present application;

FIG. 1A depicts one possible embodiment in which the pre-forms and containers are conveyed with a rotary or linear convey prior to and during the treatment process; and

FIG. 2 is a schematic side elevation of an arrangement in accordance with the present application.

FIG. 3 shows schematically the main components of one possible embodiment example of a system for filling containers, specifically, a beverage bottling plant for filling bottles 130 with at least one liquid beverage, in accordance with at least one possible embodiment, in which system or plant could possibly be utilized at least one aspect, or several aspects, of the embodiments disclosed herein.

### DESCRIPTION OF EMBODIMENT OR EMBODIMENTS

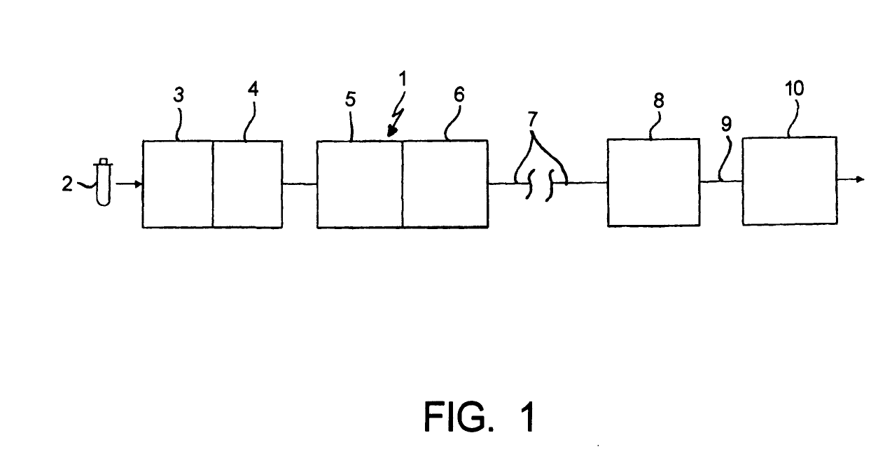

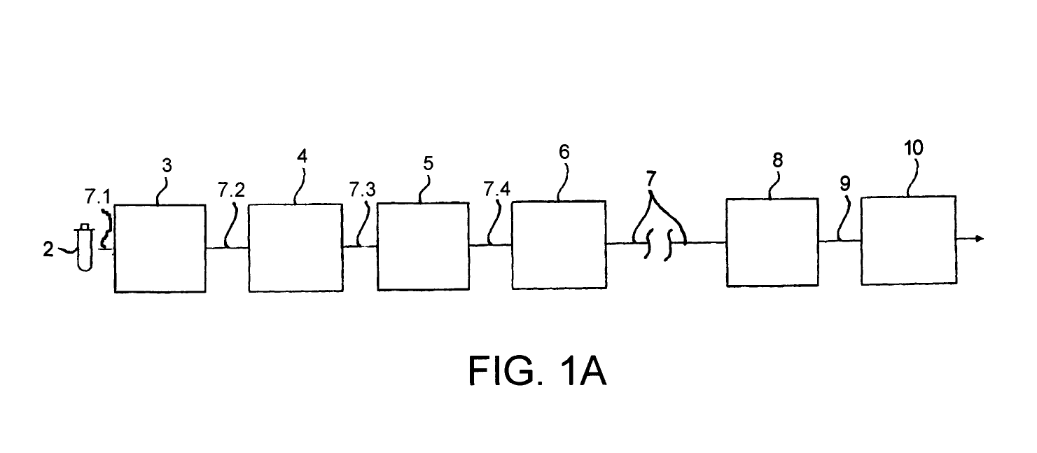

A schematic representation shows FIG. 1 as a general processing, or treatment arrangement 1 in accordance with one aspect of the present application. Completed pre-form structures, or pre-forms 2 are brought at the input-side into the arrangement. The preforms 2 first proceed through a heating station 3, in which the pre-forms 2 are preheated to a controlled temperature. Thereupon the pre-forms 2 are passed to a blow-molding station 4, in which the pre-forms 2 are brought to the desired container form. For example, the desired container form could be a bottle for beverages, or drinks. The desired form is brought about by blowing to expand the pre-forms 2 in blow molds.

FIG. 1A depicts one possible embodiment in which the pre-forms 2 could enter the heating arrangement 3 by means of either a rotary or linear conveyer 7.1. The pre-forms 2 are heated to a temperature desirable for blow-molding. The pre-forms 2 could then be passed from the heating station 3 to the blow-molding station 4 by either a rotary or linear conveyor 7.2. The pre-forms 2 are blow molded into the desired container form. The formed, blow-molded containers may be passed from the blow-molding station 4 to the spraying station 5 by means of either a rotary or linear conveyer 7.3. The spray station 5 applies a coating that could reduce the static or friction that occurs in air transport. After being sprayed, the blow-molded containers could be moved to the drying station 6 by means of either a rotary or linear conveyor 7.4. The coating dries in the drying station 6. When dried, the blow-molded containers are ready for air transport along the air transport system 7 to the rinser 8. The rinser 8 removes the excess treatment coating from the blow-molded containers. The blow-molded containers are then moved by another air transport system 9 to the filling station 10. The blow-molded containers are then filled at filling station 10. Additional air transport systems leading to other treatment stations could follow, such as a capping station, labeling station, and/or packaging station.

Subsequently following the shaping of the finished form, the containers 11 are introduced into the spraying station 5 dried in the drying station 6. Thereupon the containers 11 are supplied by means of an air transport system 7, which also serves as a buffer distance, to a rinser, or rinser station 8. In the rinser station 8, the interiors of the containers are cleaned and sterilized if desired. Then the sterilized containers are supplied, by means of another air transport system 9, to a filling arrangement or filling station 10, in which the containers 11 are filled with the desired filling material. Alternatively, other processing configurations are also possible, such as a capping station, labeling station, and/or packaging station.

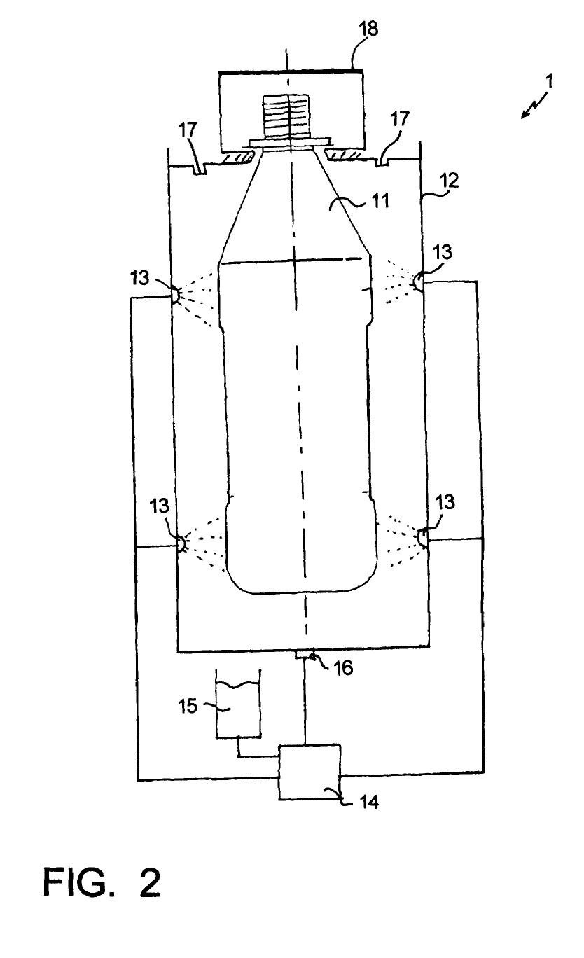

The details and/or the possible construction of the treatment or processing arrangement 1 is more clearly illustrated in FIG. 2, and explained in the following. A finished blow-molded container 11 of plastic material is transported, after leaving the blow-molding machine, through a spraying chamber 12. In the spraying chamber 12, a plurality of atomizer nozzles 13 is provided, which prepares a mist of the treatment means. The mist of the treatment means is in finely divided form, and thus, the atomizer nozzles 13 generate a spray and/or fog. In other words, the atomizer nozzles 13 generate a spray and/or fog within the spraying chamber 12.

The treatment means or medium can, for instance, be carried by a carrier means, such as water. Effective components may be added to the carrier means, for instance in the form of detergents, silicones, or Teflon. The resultant spray and/or fog is deposited on the surface of the container 11.

Due to any of the remaining heat of the container 11, which it still may contain, on account of being directly passed from the blow-molding stage, the carrier means evaporate upon the container 11 leaving the spray chamber 12. In other words, the container 11 may still have residual heat from the blow molding stage. This heat may help to evaporate the carrier means, or water-based part of the treatment solution, from the surface of the container. Thus, the container 11 dries, and on the container's surface, there remains a layer of the effective component, or treatment layer. The treatment layer may be in the form, for instance, of a thin silicone layer, or Teflon layer. This layer considerably decreases the friction of the containers with respect to one another. Furthermore, an equilibrium condition, or a substantial reduction of available electrostatic surface charge takes place by spraying, or charges of electrostatic surface loads, that, perhaps, might have formed on account of the blow-molding stage on the surface of the container 11, so that interactions between two containers 11 substantially do not arise any longer, or as substantially lessened effects. In other words, electrostatic surface loads may have formed on the surface of containers 11, as a result of the blow molding stage. The spray treatment may reduce the occurrence of these surface loads forming on the containers 11. Therefore, containers could be less prone to interact because of the spray treatment. Chilling, or cooling nozzles 17, which are connected to the air supply of the air transport system, support the drying process. Ergo, in addition, the surface of the container 11 is dried by blowing air about the surface.

In one possible embodiment, a chemical could be added to a plastic part for the purpose of eliminating or lessening static electricity such as an antistatic agent or static reducing material. An antistatic agent or static reducing material could permit the body or surface of the container to be slightly conductive which may prevent the formation of static charges. The agent could be applied to the surface after molding, and function either by being inherently conductive or by absorbing moisture from the air. Examples of antistatic additives are long-chain aliphatic amines and amides, phosphate esters, quaternary ammonium salts, polyethylene glycols, polyethylene glycol esters, and ethoxylated long-chained aliphatic amines.

For the production of the spray, and/or fog, a pump equipment 14 is provided for the means of treatment from a stock container 15, to pump these means to the atomizer nozzles 13 and provide there the desired pressure for the production of the spray and/or fog. Excess medium of treatment which is not deposited on the surface of the bottles 11 condenses on the walls of the spray chamber 12, or is deposited thereon, runs off in downward direction and is supplied by way of a drainage 16 again to the pump equipment 14, so that, for instance, a part of the means of treatment circulates in a closed cycle.

In one possible example of this embodiment, a treatment means such as a silicon solution or mixture could be stored in the stock container 15. A bottle 11 is positioned in spray chamber 12 to receive a spray coating of the silicon solution or mixture. The pump equipment 14 pressurizes and pumps the silicon solution or mixture to the atomizer nozzles 13, so as to provide a spray or mist of the silicon solution to coat the surface of the bottle 11. The excess silicon solution runs into a drainage 16, and again into the pump equipment 14.

Following the spray chamber 12 there may be provided an independent drying station, or chamber 6 in the arrangement according to the described embodiment which supports the drying of the containers 11, and therefore, the forming of the film of the effective component, which chamber functions in addition to the already described drying mechanism comprising relevant radiation with infrared light, or an additional flow of hot air.

In other words, the containers 11 enter a drying station 6 after being treated in the spray chamber 12. The drying station 6 helps form a film on the surface of the container 11. The film is configured to reduce, restrict, or minimize the contact of the containers 11 with one another during air transport. The drying means of chamber 6 could comprise infrared light, or hot air.

Prior to, during, or after treatment of the container 11 in the spray chamber 12, in accordance with the present application, the container 11 will be passed to an air transport system 18. The air transport system 18 moves the container 11 by way of projections configured as nozzles, or gill-like formations by accordingly formed air currents. By way of the procedure in accordance with the present application, the containers 11 can bump into one another during transport, without becoming wedged to one another. Should the containers be pushed in a group and are transported in this manner, or should they possibly turn, or rotate mutually with respect to one another, or collide at different speeds, the containers do not wedge tight, or do not get stuck to one another. This is because the surface friction and/or the electrostatic interaction between the containers has been lowered by the treatment, in accordance with the present application, so that a reciprocal effect between adjacent containers substantially does not arise.

The present application is limited not only to the preceding embodiment example, but also can be modified in a variety of embodiments without leaving the basic idea, or concept underlying the present application. Thus, the used treatment means, the carrier media, or effective components are modifiable in wide areas, as long as they are suitable to affect the container surface in suitable way so as to influence, in one possible embodiment, the reduction of the friction of the containers. Also the construction of the relevant arrangement, or equipment, for example the collection of the medium and, if or desired, the subsequent drying can be carried out in a variety of ways, as long as a sufficient amount of the treatment means is brought to the relevant places of the container surface. Also the configuration, or construction of the arrangement can be varied in one possible embodiment with respect to the arrangement, or configuration of the other treatment stations that follow the treatment station, or device in accordance with the present application. Furthermore, it is also possible to locate the treatment device, or station even at other locations in the production line, or combine the station with other plant stations other than the blow-molding station. The transport, or conveying systems are not limited to the air transport systems.

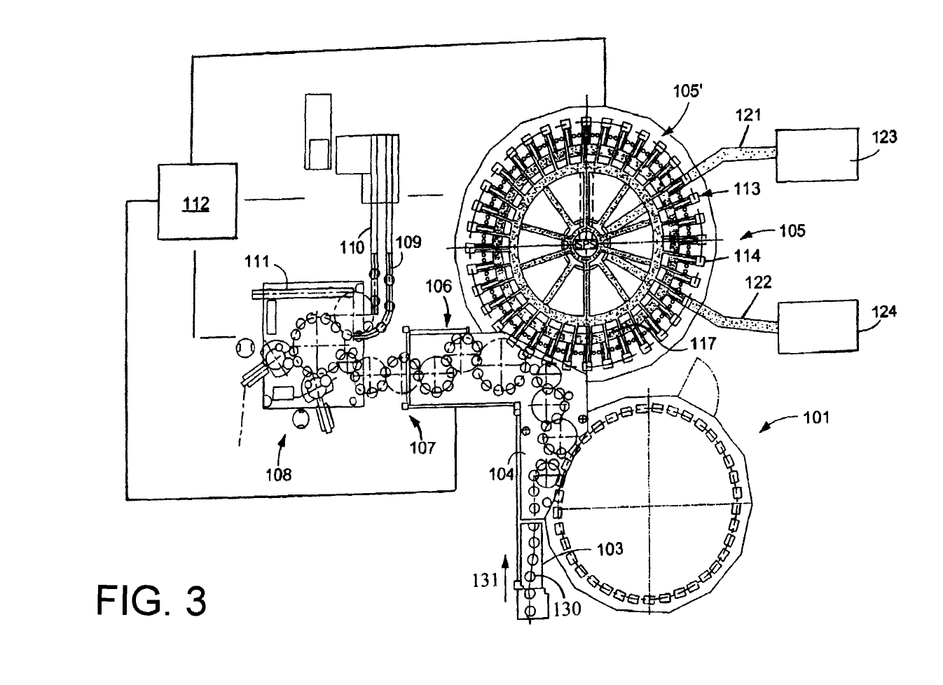

FIG. 3 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 3, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle 130, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 is connected by a starwheel conveyer structure to three output conveyer arrangements: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

One feature or aspect of an embodiment is believed at the time of the filing of this patent application to possibly reside broadly in a procedure for the treatment of containers made from plastic material, wherein that the containers 11 are treated upon molding for the substantial removal, and/or the creation of an equilibrium of electrostatic surface loads, and/or for the reduction of the surface friction.

Another feature or aspect of an embodiment is believed at the time of the filing of this patent application to possibly reside broadly in the procedure wherein the containers 11 are sprayed with means configured to reduce friction.

Yet another feature or aspect of an embodiment is believed at the time of the filing of this patent application to possibly reside broadly in the procedure wherein as the means there is used a mixture of a carrier means and effective component.

Still another feature or aspect of an embodiment is believed at the time of the filing of this patent application to possibly reside broadly in the procedure wherein as carrier means water is used.

A further feature or aspect of an embodiment is believed at the time of the filing of this patent application to possibly reside broadly in the procedure wherein effective component materials from the groups of detergents, silicones, polytetrafluoroethylene (Teflon), are used.

Another feature or aspect of an embodiment is believed at the time of the filing of this patent application to possibly reside broadly in the procedure wherein the containers 11 are dried after spraying.

Yet another feature or aspect of an embodiment is believed at the time of the filing of this patent application to possibly reside broadly in the procedure wherein the drying is caused by the residual heat of the containers 11 as provided by the blow-molding stage, and/or by used air from the air transport, and/or by a drying station.

Still another feature or aspect of an embodiment is believed at the time of the filing of this patent application to possibly reside broadly in the procedure wherein the device for the treatment of containers made from plastic material according to the present application.

A further feature or aspect of an embodiment is believed at the time of the filing of this patent application to possibly reside broadly wherein a plurality of atomizer nozzles is used for the application of means for the reduction of friction onto the surface of the containers.

Another feature or aspect of an embodiment is believed at the time of the filing of this patent application to possibly reside broadly wherein a pump equipment is provided for the supply to the atomizer nozzles of the means for the reduction of friction.

Yet another feature or aspect of an embodiment is believed at the time of the filing of this patent application to possibly reside broadly in an equipment is provided for collection of an excess of the means for the reduction of friction which equipment is connected to the pump equipment.

With a procedure and a device for the treatment of containers made from plastic material, a solution is given to treat container in a manner that they can be transported with less susceptibility to disruptions, while the interaction of the containers among each other is decreased.

This is reached by the fact that the containers are treated after the blow-molding stage for the substantial elimination, and/or the creation of an equilibrium with respect to electrostatic surface loads, and/or for the reduction of the surface friction.

Another feature or aspect of an embodiment is believed at the time of the filing of this patent application to possibly reside broadly in a method of making, transporting, filling, and capping a beverage bottle in a beverage bottling plant; said method comprising the steps of: conveying a pre-form structure, comprising a plastic material, to a heating arrangement with a first conveyor system; heating said pre-form structure with said heating arrangement; conveying said heated pre-form structure from said heating arrangement to a blow-molding arrangement with a second conveyor system; blow-molding said heated pre-form structure with said blow-molding arrangement, and producing a finished plastic beverage bottle; conveying said finished plastic beverage bottle from said blow-molding arrangement to a spray chamber with a third conveyor system; spraying the exterior surface of said finished plastic beverage bottle, in a spray chamber, with an electrostatic- and/or friction-reducing material configured to minimize, restrict, or inhibit electrostatic buildup on the exterior surface of said finished plastic beverage bottle and/or friction on the exterior surface of said finished plastic beverage bottle, to minimize, restrict, or inhibit sticking together of finished plastic beverage bottles, thus minimizing, restricting, or inhibiting bottle jams during the use of an air transport system; conveying said finished plastic beverage bottle from said blow-molding arrangement to a drying arrangement with a fourth conveyor system; drying said static- and/or friction-reducing material on the exterior surface of said finished plastic beverage bottle; transporting said finished plastic beverage bottle with a first air transport system from said drying arrangement to a rinsing arrangement, with surface electrostatic and/or surface friction of said finished plastic beverage bottle minimized, restricted or inhibited, and minimizing, restricting, or inhibiting said finished plastic beverage bottle from sticking, upon contact with other finished plastic beverage bottles, during said transporting; rinsing the interior of said finished plastic beverage bottle and removing contaminants, including remnants of said electrostatic- and/or friction-reducing material; rinsing the exterior of said finished plastic beverage bottle and removing contaminants, including remnants of said electrostatic- and/or friction-reducing material; transporting said finished plastic beverage bottle with a second air transport system from said rinsing arrangement to a filling arrangement; filling said finished plastic beverage bottle at said filling arrangement; conveying said filled finished plastic beverage bottle from said filling arrangement to a capping arrangement with a fifth conveying system; and capping said filled finished plastic beverage bottle with said capping arrangement.

Yet another feature or aspect of an embodiment is believed at the time of the filing of this patent application to possibly reside broadly in a beverage bottle treatment arrangement comprising: a first conveyor system being configured to convey a pre-form structure, comprising a plastic material, to a heating arrangement; a heating arrangement being configured to heat a pre-form structure; a second conveyor system being configured to convey a pre-form structure from said heating arrangement to a blow-molding arrangement; a blow-molding arrangement being configured to blow-mold a pre-form structure to produce a finished plastic beverage bottle; a third conveyor system being configured to convey a finished plastic beverage bottle from said blow-molding arrangement to a spray chamber; a spraying arrangement, comprising a spray chamber, being configured to spray the exterior of a finished plastic beverage bottle with an electrostatic- and/or friction-reducing material to minimize, restrict, or inhibit electrostatic buildup on the exterior surface of said finished plastic beverage bottle and/or friction of the exterior surface of a finished plastic beverage bottle to minimize, restrict, or inhibit sticking together of finished plastic beverage bottles, thus minimizing, restricting, or inhibiting bottle jams during use of an air transport system; a forth conveyor system being configured to convey a finished plastic beverage bottle from said spraying arrangement to a drying arrangement; a drying arrangement being configured to dry a static- and or friction-reducing material on the surface of a finished plastic beverage bottle; a first air transport system being configured to transport a finished plastic beverage bottle from said drying arrangement to a rinsing arrangement, with surface electrostatic and/or surface friction of a finished plastic beverage bottle minimized, restricted, or inhibited, and minimizing, restricting, or inhibiting a finished plastic beverage bottle from sticking, upon contact with other finished plastic beverage bottles, during transport; a rinsing arrangement being configured to rinse the interior of a finished plastic beverage bottle to remove contaminants, including remnants of the static- and/or friction-reducing material; said rinsing arrangement is further configured to rinse the exterior of a finished plastic beverage bottle to remove contaminants, including remnants of the static- and/or friction-reducing material; a second air transport system being configured to transport a finished plastic beverage bottle from said rinsing arrangement to a filling arrangement; a filling arrangement being configured to fill a finished plastic beverage bottle; a fifth conveyor system being configured to convey a finished plastic beverage bottle from said filling arrangement to a capping arrangement; and a capping arrangement being configured to cap a finished plastic beverage bottle.

Still another feature or aspect of an embodiment is believed at the time of the filing of this patent application to possibly reside broadly in a method of treating and transporting containers, said method comprising the steps of: treating the exteriors of finished plastic containers with a static- and/or friction-reducing material to minimize, restrict, or inhibit static buildup on the exterior of finished plastic containers and/or friction on the exterior of finished plastic containers upon transport thereof to thus minimize, restrict, or inhibit finished plastic containers from being substantially misaligned during transport, and to thus minimize, restrict, or inhibit jams during transport of finished plastic containers; and transporting treated finished plastic containers between container handling arrangements, with static buildup on the exterior of said finished plastic container and/or friction on the exterior of finished plastic containers being minimized, restricted, or inhibited during transport.

A further feature or aspect of an embodiment is believed at the time of the filing of this patent application to possibly reside broadly in a means for treating and transporting containers, said means comprising: means for treating the exteriors of finished plastic containers, with a static- and/or friction-reducing material, which static- and/or friction-reducing material is configured to minimize, restrict, or inhibit static buildup on the exteriors of finished plastic containers and/or friction on the exteriors of finished plastic container upon transport thereof, to thus minimize, restrict, or inhibit finished plastic containers from being substantially misaligned during transport, and to thus minimize, restrict, or inhibit jams in transport of finished plastic containers; and means for transporting treated finished plastic containers, between container handling arrangements, with static buildup on the exteriors of finished plastic containers and/or friction on the exteriors of finished plastic containers minimized, restricted, or inhibited during transport.

Another feature or aspect of an embodiment is believed at the time of the filing of this patent application to possibly reside broadly in a container treatment arrangement comprising: a treating arrangement being configured to treat the exteriors of finished plastic containers with a static- and/or friction-reducing material, to minimize, restrict, or inhibit static buildup on the exteriors of finished plastic containers and/or friction on the exteriors of finished plastic containers upon transport thereof, and being configured to minimize, restrict, or inhibit finished plastic containers from being substantially misaligned during transport, and to thus minimize, restrict, or inhibit jams in transport of finished plastic containers; and a transporting arrangement being configured to transport treated finished plastic containers between container handling arrangements, with static buildup on the exteriors of finished plastic containers and/or friction on the exteriors of finished plastic containers minimized, restricted, or inhibited during transport.

Yet another feature or aspect of an embodiment is believed at the time of the filing of this patent application to possibly reside broadly in treating the exteriors of finished plastic containers with a friction reducing material further comprises spraying the exteriors of finished plastic containers with said friction reducing material.

Still another feature or aspect of an embodiment is believed at the time of the filing of this patent application to possibly reside broadly in said friction reducing material comprises one of (I) and (II): (I) a mixture of (a) and (b): (a) a vehicle; and (b) a component configured to restrict, inhibit, or minimize friction; and (II) a mixture of (c) and (d): (c) a vehicle comprising water; and (d) a component configured to restrict, inhibit, or minimize friction.

A further feature or aspect of an embodiment is believed at the time of the filing of this patent application to possibly reside broadly in said component configured to restrict, inhibit, or minimize friction, comprises at least one of: detergents, silicones, and polytetrafluoroethylene (Teflon).

Another feature or aspect of an embodiment is believed at the time of the filing of this patent application to possibly reside broadly in said method further comprises drying finished plastic containers after said step of spraying the exterior of finished plastic containers with said friction reducing material; said method further comprises blow molding plastic pre-forms to produce finished plastic containers; said step of transporting finished plastic containers between container handling arrangements further comprises transporting with air; said step of drying finished plastic containers further comprises at least one of (e), (f), and (g): (e) allowing any residual heat from said step of blow molding to dry said friction reducing material on the exterior of finished plastic containers; (f) allowing air from said step of transporting, with air, to dry said friction reducing material on the exterior of finished plastic containers; and (g) drying said friction reducing material on the exterior of finished plastic containers with a drying arrangement; said step of spraying said friction reducing material onto the surface of finished plastic containers comprises spraying with a plurality of atomizer nozzles; said method further comprises supplying said friction reducing material to said plurality of atomizer nozzles with a pump arrangement; said method further comprises collecting an excess of said friction reducing material with a collecting arrangement; and said collecting arrangement is operatively connected to said pump arrangement.

Yet another feature or aspect of an embodiment is believed at the time of the filing of this patent application to possibly reside broadly in a container treatment arrangement comprising: a conveyor arrangement being configured to convey finished plastic containers to a first treating arrangement; a treating arrangement being configured to treat the exterior of finished plastic containers with a static- and/or friction-reducing material, to minimize, restrict, or inhibit static build up on the exteriors of finished plastic containers and/or friction on the exterior of finished plastic containers upon transport, and being configured to minimize, restrict, or inhibit finished plastic containers from being substantially misaligned during transport, and thus to minimize jams in transport of finished plastic containers; and said conveyor arrangement being further configured to convey finished plastic containers, with static and/or friction minimized, restricted, or inhibited, from said treating arrangement to a container handling arrangement, with static buildup on the exteriors of finished plastic containers and/or friction on the exteriors of finished plastic containers minimized, restricted, or inhibited, and to minimize, restrict, or inhibit finished plastic containers from being substantially misaligned during transport, and thus to minimize, restrict, or inhibit jams of finished plastic containers.

Another feature or aspect of an embodiment is believed at the time of the filing of this patent application to possibly reside broadly in said treating arrangement is configured to spray finished plastic containers with said spraying apparatus; and said spraying apparatus is configured to spray said friction reducing material.

Yet another feature or aspect of an embodiment is believed at the time of the filing of this patent application to possibly reside broadly in said treating arrangement is configured to spray the friction reducing material which comprises a mixture of: a vehicle; and a component configured to restrict, inhibit, or minimize electrostatic.

Still another feature or aspect of an embodiment is believed at the time of the filing of this patent application to possibly reside broadly in said treating arrangement is configured to spray the vehicle which comprises water.

A further feature or aspect of an embodiment is believed at the time of the filing of this patent application to possibly reside broadly in said treating arrangement is configured to spray the component which comprises at least one of: detergents, silicones, and polytetrafluoroethylene (Teflon).

Another feature or aspect of an embodiment is believed at the time of the filing of this patent application to possibly reside broadly in said container treatment arrangement further comprises a drying arrangement configured to dry the friction reducing material on the exteriors of finished plastic containers.

Yet another feature or aspect of an embodiment is believed at the time of the filing of this patent application to possibly reside broadly in said container treatment arrangement further comprises: a plurality of atomizer nozzles; a pump arrangement; a collecting arrangement; a blow molding arrangement; and an air transport system; said blow molding arrangement is configured to blow mold plastic pre-form structures into finished plastic containers; said air transport system is configured to transport finished plastic containers from said first treating arrangement to said second treating arrangement; said container treatment arrangement is further configured to perform at least one of (a), (b), and (c): (a) allow any residual heat from said blow molding arrangement to dry the friction reducing material on finished plastic containers; (b) allow air from said air transport system to dry the friction reducing material on the exteriors of finished plastic containers; and (c) dry the friction reducing material on the exteriors of finished plastic containers with said drying arrangement; said first treating arrangement comprises said plurality of atomizer nozzles configured to apply the friction reducing material onto the surfaces of finished plastic containers; said pump arrangement said pump arrangement comprises said plurality of atomizer nozzles; said pump equipment is configured to supply said atomizer nozzles with the friction reducing material; said collecting arrangement is configured to collect an excess of the friction reducing material; and said collecting arrangement is operatively connected to said pump arrangement.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, which were cited in the International Search Report dated Jun. 2, 2008, and/or cited elsewhere are hereby incorporated by reference as if set forth in their entirety herein as follows: WO 2006/010141, having the title “COATING PROCESS AND APPARATUS FOR FORMING COATED ARTICLES”, published on Jan. 26, 2006; and EP 0 253 026 A, having the title “METHOD AND APPARATUS FOR COATING AND CURING CONTAINERS”, published on Jan. 20, 1988.

All of the patents, patent applications or patent publications, which were cited in the German Office Action dated Dec. 12, 2007, and/or cited elsewhere are hereby incorporated by reference as if set forth in their entirety herein as follows: DE 102 54 762 A1, having the following English translation of the German title “METHOD FOR THE PRODUCTION AND/OR HANDLING OF A HIGHLY PURE OBJECT”, published Jun. 9, 2004; DE 699 11 381 T2, having the following English translation of the German title “COATING SYSTEM PROVIDING LOW FRICTION”, published Jun. 24, 2004; DE 699 10 982 T2, having the following German title “MEDIZINISCHER ARTIKEL MIT BESCHICHTETER OBERFLÄCHE MIT NIEDRIGER REIBUNG UND GERINGER EIWEISSADSORPTION”, published Jul. 15, 2004.

Some examples of static reducing materials or antistatic agents for the treatment of plastic surfaces that may be possibly utilized or adapted for use in at least one possible embodiment may possibly be found in the following U.S. Pat. No. 4,888,243, having the title “PROCESS FOR ANTISTATIC TREATMENT OF PLASTIC MOLDINGS”, issued on Dec. 19, 1989; and U.S. Pat. No. 5,372,924, having the title “ANTISTATIC PLASTIC MOLDINGS”, issued on Dec. 13, 1994.

Some examples of atomizer nozzles or sprayer nozzles and pump equipment for the operation thereof that may be possibly utilized or adapted for use in at lease one possible embodiment may possible be found in the following U.S. Pat. No. 7,010,900 B2, having the title “BEVERAGE BOTTLING PLANT FOR FILLING BEVERAGE BOTTLES WITH A LIQUID FILLING MATERIAL, AND A CLEANING DEVICE FOR CLEANING BOTTLES IN A BEVERAGE BOTTLING PLANT”, issued on Mar. 14, 2006; and U.S. Pat. No. 6,374,575 B1, having the title “BOTTLING PLANT AND METHOD OF OPERATING A BOTTLING PLANT”, issued on Apr. 23, 2002.

Some examples of air transport systems that may possibly be utilized or adapted for use in at least one possible embodiment may be found in the following U.S. Pat. No. 5,820,306, having the title “THRUST SLOT AIR CONVEYOR”, issued on Oct. 13, 1998; and U.S. Pat. No. 5,028,174, having the title “APPARATUS FOR TRANSPORTING BOTTLES”, issued on Jul. 2, 1991.

U.S. patent application Ser. No. 11/624,483 filed on Jan. 18, 2007, having inventor Volker TILL, Attorney Docket No. NHL-HOL-152, and title “BEVERAGE BOTTLING PLANT FOR FILLING BEVERAGE BOTTLES WITH A LIQUID BEVERAGE MATERIAL AND METHOD OF OPERATION THEREOF”, and its corresponding Federal Republic of Germany Patent Application No. 10 2006 002 632.2, filed on Jan. 19, 2006 and inventor Volker TILL, are hereby incorporated by reference as if set forth in their entirety herein.

U.S. patent application Ser. No. 11/690,624, filed on Mar. 23, 2007, having inventor Volker TILL, Attorney Docket No. NHL-HOL-160, and title “BEVERAGE BOTTLING OR CONTAINER FILLING PLANT HAVING A BEVERAGE BOTTLE OR CONTAINER HANDLING MACHINE AND A METHOD OF OPERATION THEREOF”, and its corresponding Federal Republic of Germany Patent Application No. DE 2006 013 843.0, filed on Mar. 25, 2006, and inventor Volker TILL, are hereby incorporated by reference as if set forth in their entirety herein.

The patents, patent applications, and patent publications listed above, in the preceding seven paragraphs beginning the phrase: “All of the patents, patent applications or patent publications, which were cited . . . ” and ending with the phrase: “ . . . are hereby incorporated by reference as if set forth in their entirety herein” are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 049 134.3, filed on Oct. 18, 2006 and Federal Republic of Germany Patent Application No. 20 2006 015 912.6 Oct. 18, 2006, having inventors, and DE-OS 10 2006 049 134.3 and DE-OS 20 2006 015 912.6, and DE-PS 10 2006 049 134.3 and DE-PS 20 2006 015 912.6, and International Application No. PCT/EP2007/08931, filed on Oct. 15, 2007, having WIPO Publication No. WO/2008/046574 A2 and inventors Micheal HOHENHORST and Martin BACKHAUS, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/08931, and DE 10 2006 049 134.3 and DE 20 2006 015 912.6 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/08931, and DE 10 2006 049 134.3 and DE 20 2006 015 912.6 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1 Device for treatment
2 Pre-form structure, or precursor structure
3 Heating station
4 Blow-molding station
5 Spray station
6 Drying station
7 Air transport system
8 Rinser
9 Air transport system
10 Filling arrangement or filling station
11 Containers
12 Spray chamber
13 Atomizer nozzles
14 Pump equipment
15 Stock container
16 Drainage
17 Chilling nozzles
18 Air transport system

What is claimed is:

1. A method of making, transporting, filling, and capping a beverage bottle in a beverage bottling plant;
said method comprising the steps of:
conveying a pre-form structure, comprising a plastic material, to a heating arrangement with a first conveyor system;
heating said pre-form structure with said heating arrangement;
conveying said heated pre-form structure from said heating arrangement to a blow-molding arrangement with a second conveyor system;
blow-molding said heated pre-form structure with said blow-molding arrangement, and producing a finished plastic beverage bottle;
conveying said finished plastic beverage bottle from said blow-molding arrangement to a spray chamber with a third conveyor system;
spraying the exterior surface of said finished plastic beverage bottle, in a spray chamber, with an electrostatic- and/or friction-reducing material configured to minimize, restrict, or inhibit electrostatic buildup on the exterior surface of said finished plastic beverage bottle and/or friction on the exterior surface of said finished plastic beverage bottle, to minimize, restrict, or inhibit sticking together of finished plastic beverage bottles, thus minimizing, restricting, or inhibiting bottle jams during the use of an air transport system;
conveying said finished plastic beverage bottle from said blow-molding arrangement to a drying arrangement with a fourth conveyor system;
drying said static- and/or friction-reducing material on the exterior surface of said finished plastic beverage bottle;
transporting said finished plastic beverage bottle with a first air transport system from said drying arrangement to a rinsing arrangement, with surface electrostatic and/or surface friction of said finished plastic beverage bottle minimized, restricted or inhibited, and minimizing, restricting, or inhibiting said finished plastic beverage bottle from sticking, upon contact with other finished plastic beverage bottles, during said transporting;
rinsing the interior of said finished plastic beverage bottle and removing contaminants, including remnants of said electrostatic- and/or friction-reducing material;
rinsing the exterior of said finished plastic beverage bottle and removing contaminants, including remnants of said electrostatic- and/or friction-reducing material;
transporting said finished plastic beverage bottle with a second air transport system from said rinsing arrangement to a filling arrangement;
filling said finished plastic beverage bottle at said filling arrangement;
conveying said filled finished plastic beverage bottle from said filling arrangement to a capping arrangement with a fifth conveying system; and
capping said filled finished plastic beverage bottle with said capping arrangement.

2. The method according to claim 1, wherein said method further comprises:
conveying said finished plastic container to additional treating arrangements, with static buildup on the exterior of said finished plastic container and/or friction on the exterior of said finished plastic container minimized, restricted, or inhibited; and
minimizing, restricting, or inhibiting said finished plastic container from being substantially misaligned during transport, and thus minimizing, restricting, or inhibiting jams of finished plastic containers.

3. A beverage bottle treatment arrangement for performing the method of claim 1, said beverage bottle treatment arrangement comprising:
a first conveyor system being configured to convey a pre-form structure, comprising a plastic material, to a heating arrangement;
a heating arrangement being configured to heat a pre-form structure;
a second conveyor system being configured to convey a pre-form structure from said heating arrangement to a blow-molding arrangement;
a blow-molding arrangement being configured to blow-mold a pre-form structure to produce a finished plastic beverage bottle;
a third conveyor system being configured to convey a finished plastic beverage bottle from said blow-molding arrangement to a spray chamber;
a spraying arrangement, comprising a spray chamber, being configured to spray the exterior of a finished plastic beverage bottle with an electrostatic- and/or friction-reducing material to minimize, restrict, or inhibit electrostatic buildup on the exterior surface of said finished plastic beverage bottle and/or friction of the exterior surface of a finished plastic beverage bottle to minimize, restrict, or inhibit sticking together of finished plastic beverage bottles, thus minimizing, restricting, or inhibiting bottle jams during use of an air transport system;
a fourth conveyor system being configured to convey a finished plastic beverage bottle from said spraying arrangement to a drying arrangement;
a drying arrangement being configured to dry a static- and or friction-reducing material on the surface of a finished plastic beverage bottle;
a first air transport system being configured to transport a finished plastic beverage bottle from said drying arrangement to a rinsing arrangement, with surface electrostatic and/or surface friction of a finished plastic beverage bottle minimized, restricted, or inhibited, and minimizing, restricting, or inhibiting a finished plastic beverage bottle from sticking, upon contact with other finished plastic beverage bottles, during transport;
a rinsing arrangement being configured to rinse the interior of a finished plastic beverage bottle to remove contaminants, including remnants of the static- and/or friction-reducing material;
said rinsing arrangement is further configured to rinse the exterior of a finished plastic beverage bottle to remove contaminants, including remnants of the static- and/or friction-reducing material;
a second air transport system being configured to transport a finished plastic beverage bottle from said rinsing arrangement to a filling arrangement;
a filling arrangement being configured to fill a finished plastic beverage bottle;
a fifth conveyor system being configured to convey a finished plastic beverage bottle from said filling arrangement to a capping arrangement; and
a capping arrangement being configured to cap a finished plastic beverage bottle.

4. A method of treating and transporting containers, said method comprising the steps of:
treating the exteriors of finished plastic containers with a static- and/or friction-reducing material to minimize, restrict, or inhibit static buildup on the exterior of finished plastic containers and/or friction on the exterior of finished plastic containers upon transport thereof to thus minimize, restrict, or inhibit finished plastic containers from being substantially misaligned during transport, and to thus minimize, restrict, or inhibit jams during transport of finished plastic containers; and
transporting treated finished plastic containers between container handling arrangements, with static buildup on the exterior of said finished plastic container and/or friction on the exterior of finished plastic containers being minimized, restricted, or inhibited during transport.

5. The method according to claim 4, wherein said step of treating the exteriors of finished plastic containers with a friction reducing material further comprises spraying the exteriors of finished plastic containers with said friction reducing material.

6. The method according to claim 5, wherein said friction reducing material comprises one of (I) and (II):
(I) a mixture of (a) and (b):
(a) a vehicle; and
(b) a component configured to restrict, inhibit, or minimize friction; and
(II) a mixture of (c) and (d):
(c) a vehicle comprising water; and
(d) a component configured to restrict, inhibit, or minimize friction.

7. The method according to claim 6, wherein said component configured to restrict, inhibit, or minimize friction, comprises at least one of: detergents, silicones, and polytetrafluoroethylene (Teflon).

8. The method according to claim 7, wherein:
said method further comprises drying finished plastic containers after said step of spraying the exterior of finished plastic containers with said friction reducing material;
said method further comprises blow molding plastic pre-forms to produce finished plastic containers;
said step of transporting finished plastic containers between container handling arrangements further comprises transporting with air;
said step of drying finished plastic containers further comprises at least one of (e), (f), and (g):
(e) allowing any residual heat from said step of blow molding to dry said friction reducing material on the exterior of finished plastic containers;
(f) allowing air from said step of transporting, with air, to dry said friction reducing material on the exterior of finished plastic containers; and
(g) drying said friction reducing material on the exterior of finished plastic containers with a drying arrangement;
said step of spraying said friction reducing material onto the surface of finished plastic containers comprises spraying with a plurality of atomizer nozzles;
said method further comprises supplying said friction reducing material to said plurality of atomizer nozzles with a pump arrangement;
said method further comprises collecting an excess of said friction reducing material with a collecting arrangement; and
said collecting arrangement is operatively connected to said pump arrangement.

9. Means for performing the method of treating and transporting containers according to claim 4, said means comprising:
means for treating the exteriors of finished plastic containers, with a static- and/or friction-reducing material, which static- and/or friction-reducing material is configured to minimize, restrict, or inhibit static buildup on the exteriors of finished plastic containers and/or friction on the exteriors of finished plastic container upon transport thereof, to thus minimize, restrict, or inhibit finished plastic containers from being substantially misaligned during transport, and to thus minimize, restrict, or inhibit jams in transport of finished plastic containers; and
means for transporting treated finished plastic containers, between container handling arrangements, with static buildup on the exteriors of finished plastic containers and/or friction on the exteriors of finished plastic containers minimized, restricted, or inhibited during transport.

10. A container treatment arrangement for performing the method of claim 4, said container treatment arrangement comprising:
a treating arrangement being configured to treat the exteriors of finished plastic containers with a static- and/or friction-reducing material, to minimize, restrict, or inhibit static buildup on the exteriors of finished plastic containers and/or friction on the exteriors of finished plastic containers upon transport thereof, and being configured to minimize, restrict, or inhibit finished plastic containers from being substantially misaligned during transport, and to thus minimize, restrict, or inhibit jams in transport of finished plastic containers; and
a transporting arrangement being configured to transport treated finished plastic containers between container handling arrangements, with static buildup on the exteriors of finished plastic containers and/or friction on the exteriors of finished plastic containers minimized, restricted, or inhibited during transport.

11. The container treatment arrangement according to claim 10, wherein:
said container treatment arrangement further comprises a spraying apparatus;
said treating arrangement is configured to spray finished plastic containers with said spraying apparatus;
said spraying apparatus is configured to spray said friction reducing material; and
said treating arrangement is configured to spray the friction reducing material which comprises a mixture of:
a vehicle; and
a component configured to restrict, inhibit, or minimize electrostatic.

12. The container treatment arrangement according to claim 11, wherein:
said treating arrangement is configured to spray the vehicle which comprises water; and
said treating arrangement is configured to spray the component which comprises at least one of: detergents, silicones, and polytetrafluoroethylene (Teflon).

13. The container treatment arrangement according to claim 12, wherein:
said container treatment arrangement comprises:
a drying arrangement;
a plurality of atomizer nozzles;
a pump arrangement;
a collecting arrangement;
a blow molding arrangement; and
an air transport system;
said drying arrangement is configured to dry the friction reducing material on the exteriors of finished plastic containers;
said blow molding arrangement is configured to blow mold plastic pre-form structures into finished plastic containers;
said air transport system is configured to transport finished plastic containers from said first treating arrangement to said second treating arrangement;
said container treatment arrangement is further configured to perform at least one of (a), (b), and (c):
(a) allow any residual heat from said blow molding arrangement to dry the friction reducing material on finished plastic containers;
(b) allow air from said air transport system to dry the friction reducing material on the exteriors of finished plastic containers; and
(c) dry the friction reducing material on the exteriors of finished plastic containers with said drying arrangement;
said first treating arrangement comprises said plurality of atomizer nozzles configured to apply the friction reducing material onto the surfaces of finished plastic containers;
said pump arrangement said pump arrangement comprises said plurality of atomizer nozzles;
said pump equipment is configured to supply said atomizer nozzles with the friction reducing material;
said collecting arrangement is configured to collect an excess of the friction reducing material; and
said collecting arrangement is operatively connected to said pump arrangement.

14. A container treatment arrangement comprising:
a conveyor arrangement being configured to convey finished plastic containers to a first treating arrangement;
a treating arrangement being configured to treat the exterior of finished plastic containers with a static- and/or friction-reducing material, to minimize, restrict, or inhibit static build up on the exteriors of finished plastic containers and/or friction on the exterior of finished plastic containers upon transport, and being configured to minimize, restrict, or inhibit finished plastic containers from being substantially misaligned during transport, and thus to minimize jams in transport of finished plastic containers; and
said conveyor arrangement being further configured to convey finished plastic containers, with static and/or friction minimized, restricted, or inhibited, from said treating arrangement to a container handling arrangement, with static buildup on the exteriors of finished plastic containers and/or friction on the exteriors of finished plastic containers minimized, restricted, or inhibited, and to minimize, restrict, or inhibit finished plastic containers from being substantially misaligned during transport, and thus to minimize, restrict, or inhibit jams of finished plastic containers.

15. The container treatment arrangement according to claim 14, wherein:
said container treatment arrangement further comprises a spraying apparatus;
said treating arrangement is configured to spray finished plastic containers with said spraying apparatus; and
said spraying apparatus is configured to spray said friction reducing material.

16. The container treatment arrangement according to claim 15, wherein said treating arrangement is configured to spray the friction reducing material which comprises a mixture of:
a vehicle; and
a component configured to restrict, inhibit, or minimize electrostatic.

17. The container treatment arrangement according to claim 16, wherein said treating arrangement is configured to spray the vehicle which comprises water.

18. The container treatment arrangement according to claim 17, wherein said treating arrangement is configured to spray the component which comprises at least one of: detergents, silicones, and polytetrafluoroethylene (Teflon).

19. The container treatment arrangement according to claim 18, wherein said container treatment arrangement further comprises a drying arrangement configured to dry the friction reducing material on the exteriors of finished plastic containers.

20. The container treatment arrangement according to claim 19, wherein:
said container treatment arrangement further comprises:
a plurality of atomizer nozzles;
a pump arrangement;
a collecting arrangement;
a blow molding arrangement; and
an air transport system;
said blow molding arrangement is configured to blow mold plastic pre-form structures into finished plastic containers;
said air transport system is configured to transport finished plastic containers from said first treating arrangement to said second treating arrangement;
said container treatment arrangement is further configured to perform at least one of (a), (b), and (c):
(a) allow any residual heat from said blow molding arrangement to dry the friction reducing material on finished plastic containers;
(b) allow air from said air transport system to dry the friction reducing material on the exteriors of finished plastic containers; and
(c) dry the friction reducing material on the exteriors of finished plastic containers with said drying arrangement;
said first treating arrangement comprises said plurality of atomizer nozzles configured to apply the friction reducing material onto the surfaces of finished plastic containers;
said pump arrangement said pump arrangement comprises said plurality of atomizer nozzles;
said pump equipment is configured to supply said atomizer nozzles with the friction reducing material;
said collecting arrangement is configured to collect an excess of the friction reducing material; and
said collecting arrangement is operatively connected to said pump arrangement.
